(19) United States
(12) Patent Application Publication
(10) Pub. No.: US 2007/0265004 A1
(43) Pub. Date: Nov. 15, 2007

(54) System for measuring radio communicative region

(75) Inventors: Kentaro Yamada, Wako-shi (JP); Takahiro Nakamura, Wako-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Honda Motor Co., Ltd.

(21) Appl. No.: 11/797,225

(22) Filed: May 1, 2007

(30) Foreign Application Priority Data
May 1, 2006 (JP) 2006-127568

(51) Int. Cl. H04Q 7/20

(52) U.S. Cl. 455/435.1

(57) ABSTRACT

A radio communicative region measuring system is provided for measuring a region in a workspace, in which radio communication can be performed. The system has a mobile object that carries a radio transmitter for measuring a radio communicative region. A radio receiver for measuring a radio communicative region is provided in the workspace. A position detecting system such as an ultrasonic tag operating unit is provided, which included a transmitter to be carried by the mobile object and a plurality of receivers provided in the workplace. Based on radio signal received by the radio receiver and positional information provided by the position detecting system, a region in which radio communication can be performed between the radio transmitter and the radio receiver is determined.

### BACKGROUND OF THE INVENTION

1. Field of the Invention

The present invention relates to a scheme for measuring a region in which a radio communication system can communicate and for displaying the communicative region.

2. Description of the Related Art

If a communicative region under various environments is correctly recognized in a radio communication system, the types, arrangements and the number of transmitters and receivers can be optimized, improving the system design. As a conventional approach for measuring the radio communicative region, there is known a method for determining a communicative region with a tool having three axes with measurement scales. A radio tag (transmitter) is moved to measuring points in a three-dimensional space one scale at a time to check whether a receiver set at an arbitrary place can communicate with the tag at each of the measuring points.

Japanese Patent Application Publication No. 11-339079 discloses a communicative region measuring device for a radio communication apparatus applied to a non-stop toll collecting system. The device informs that the communication is normal with a beep sound when two-way communication is established between an antenna of a roadside unit (receiver) and an on-vehicle unit (transmitter). That allows a small number of persons to measure a communicative region, and to install or adjust the antenna of a roadside unit in a short time.

The conventional radio communicative region measuring method such as that disclosed in Japanese Patent Application Publication No. 11-339079 does not accurately measure a region, in which radio communication can be performed. In order to measure the radio communicative region accurately, it is necessary to increase the number of measuring points for determining whether communication can be made between a transmitter and a receiver or not. In this case, tags need to be moved many times and to many positions, which places a burden to persons who carry out the measurement.

The present invention intends to provide a system that enables a radio communicative region to be accurately measured without further burdening a person who carry out the measurement.

### SUMMARY OF THE INVENTION

The present invention provides a radio communicative region measuring system for measuring a region, in which radio communication can be performed, in a workspace. The system includes a mobile object that can move in the workspace, a transmitter for use in measuring a radio communicative region provided to the mobile object, said transmitter sending a unique radio signal, and a receiver for use in measuring a radio communicative region provided in the workspace for receiving the radio signal. The system also includes position detecting means for detecting a position of the transmitter. The system further includes computation means for measuring receiving conditions of the radio signal and position information of the transmitter detected by the position detecting means, as the mobile object moves in the workspace, for determining a region in which radio communication can be performed between the transmitter and the receiver. The transmitter for measuring a radio communicative region may be provided in the workspace and the receiver for measuring a radio communicative region may be provided to the mobile object.

According to the present invention, measurement is performed by having the mobile object move automatically, the mobile object provided with a transmitter and a receiver for measuring a radio communicative region. The load of measuring task is reduced as compared with the conventional technique. The number of measuring points can easily be increased to improve measurement of a radio communicative region in accuracy without further burdening a person who performs the measurement.

In an embodiment of the present invention, a transmitter of the radio communicative region measurement system (RCRMS) is a RFID (Radio Frequency Identification) tag and a receiver of the RCRMS is a RFID antenna. The position detecting system comprises an ultrasonic tag system with an ultrasonic transmitter and a plurality of ultrasonic receivers for detecting a position. Alternatively, the position detecting system can be an infrared tag system provided with an infrared transmitter and a plurality of infrared receivers for detecting a position.

In an embodiment of the present invention, receivers of the RCRMS are provided on a ceiling, a wall or a floor of the workspace. A transmitter of the position detecting system is placed in the same positional relationship with the transmitter or the receiver of the RCRMS provided to the mobile object, and a receiver of the position detecting system is provided to a ceiling, a wall or a floor of the workspace.

In an embodiment of the present invention, the receivers of the position detecting system are provided in the form of a grid with predetermined intervals on the ceiling, the wall or the floor of the workspace.

In an embodiment of the present invention, the transmitter of the RCRMS is a RFID tag and the receiver of the RCRMS is a RFID antenna. The RFID antenna is placed on the ceiling, the wall or the floor of the workspace. The position detecting system includes an image processing system for detecting a position of the RFID tag carried by the mobile object with one or more cameras carried by the mobile object or provided to the workspace.

In an embodiment of the present invention, the mobile object is a legged or wheeled autonomous robot.

The present invention provides a radio communicative region measuring method for measuring a region in a workplace, in which radio communication can be performed. A mobile object moves in the workspace. A unique radio signal from a transmitter of the RCRMS carried by the mobile object is received a number of times by a receiver of the RCRMS provided to the workspace. The position of the transmitter is detected by the position detecting system. The region in which radio communication can be performed between the transmitter of the RCRMS and the receiver of the RCRMS is determined based on receiving conditions of the radio signal received by the receiver of the RCRMS and position information as provided by the position detecting system. The transmitter of the RCRMS may be provided to the workspace and the receiver of the RCRMS may be carried by the mobile object.

According to an aspect of the present invention, the method comprises a step of moving a transmitter of the RCRMS in the workplace, a step of receiving a number of times a unique radio signal from the transmitter by the receiver of the RCRMS provided to the workspace, a step of detecting a position of the transmitter of the RCRMS by the position detecting system, and a step of determining a region in which radio communication can be performed based on receiving conditions of the radio signal received by the receiver of RCRMS and position information provided by the position detecting system. The transmitter of the RCRMS may be set in the workspace and the receiver of the RCRMS may be moved in the workspace.

The present invention further provides a computer program for measuring a region in the workplace, in which radio communication can be performed. A mobile object is moved in a workspace. The program performs the functions of, receiving a unique radio signal a number of times from a transmitter of the RCRMS carried by the mobile object with a receiver of the RCRMS provided to the workspace, detecting the position of the receiver by the position detecting system, and determining a region in which radio communication can be performed based on receiving conditions of the radio signal received by the receiver of the RCRMS and position information provided by the position detecting system. The transmitter of the RCRMS may be set in the workspace and the receiver of the RCRMS may be carried by the mobile object.

The present invention provides a display system for displaying a region in a workplace, in which radio communication can be performed. The display system has a transmitter of the RCRMS carried by a mobile object that can move in said workspace, the transmitter sending a unique radio signal. The display system includes a receiver of the RCRMS set in the workspace, said receiver receiving the radio signal. The display system further includes a position detecting system for detecting the position of the transmitter. Receiving conditions of the radio signal received by the receiver of RCRMS and position information provided by the position detecting system are determined as the mobile object moves in the workspace. The region in which radio communication can be performed is determined based on the receiving conditions and the position information. The region thus determined is visually displayed on a display unit. The transmitter of the RCRMS may be set in the workspace and the receiver of the RCRMS may be carried by the mobile object.

### BRIEF DESCRIPTION OF THE DRAWINGS

FIG. 1 is a schematic diagram showing RCRMS, according to an embodiment of the present invention;

FIG. 2 is a functional block diagram of the RCRMS according to the embodiment;

FIG. 3 is a flowchart of the process performed by the controller; and

FIG. 4 is an example of measurement data of the radio communicative region displayed on the display unit.

### DETAILED DESCRIPTION OF THE PREFERRED EMBODIMENTS

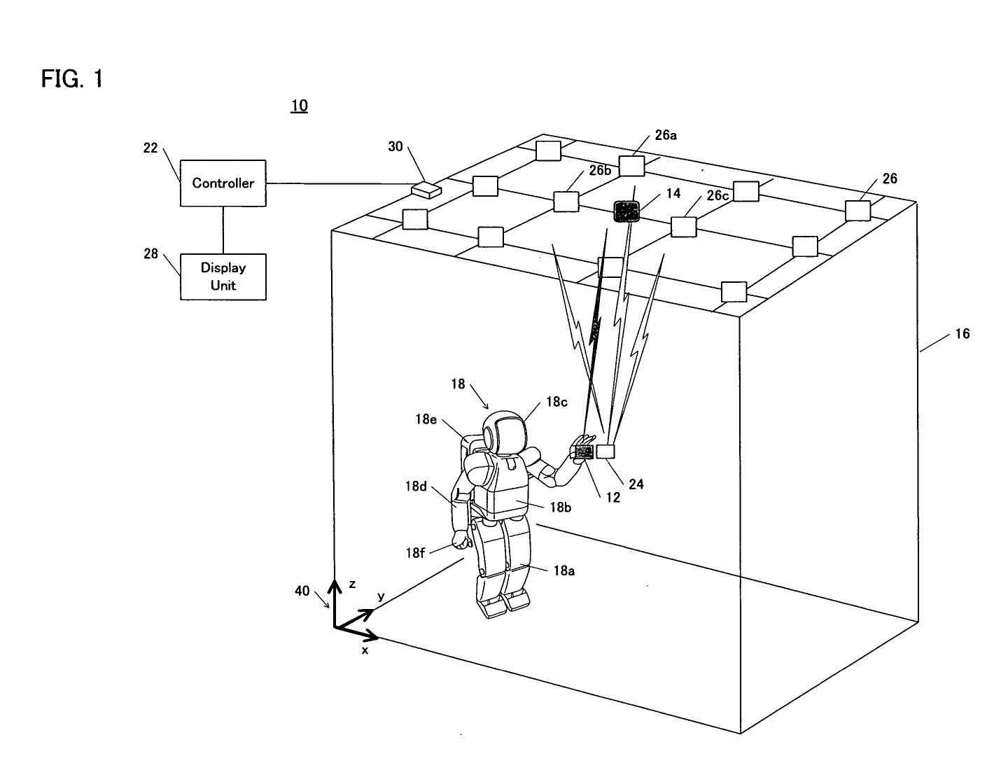

An embodiment of the present invention will be described below with reference to the drawings. FIG. 1 is a schematic diagram showing a radio communicative region measuring system (RCRMS) 10 for measuring a region in which radio communication can be performed, according to an embodiment of the present invention.

The RCRMS 10 includes the RFID (Radio Frequency Identification) tag system including an RFID tag 12 and an RFID antenna 14. It also includes an ultrasonic tag system including an ultrasonic tag 24 and ultrasonic receivers 26 for detecting position. The RCRMS 10 includes a robot 18 carrying the RFID tag 12 and the ultrasonic tag 24, the robot being capable of autonomously moving in the workspace 16. The RCRMS system includes a controller 22 that gives commands to the robot, measures the RFID antenna 14 and the ultrasonic receivers 26 at multiple measuring points in the workplace as the robot 18 moves. The controller determines a radio communicative region of the RFID tag 12 with the RFID antenna 14 based on the measurement. The system 10 may include a display unit 28 for graphically displaying the radio communicative region determined by the controller 22.

In the embodiment, the RFID tag system is used for measurement.

With the RFID tag system, the RFID tag 12 storing a unique identifier (ID) is attached to the object and the object is recognized by ID information (hereinafter referred to as the “tag ID”) of the RFID tag 12, which is received by the RFID antenna 14.

In the embodiment, the RFID tag 12 is placed on a palm part of the hand 18f of the robot 18 and moves in the workspace 16 as the robot 18 moves. The RFID antenna 14 is set in a place in the workspace 16 (on the ceiling in FIG. 1). The controller 22 measures a region, in which radio communication of the RFID tag system can be performed, by sending an instruction to the RFID tag 12 via a base station 30 instructing RFID tag 12 to transmit a radio signal while the robot 18 is moving. The controller monitors the receiving conditions of the radio signal by the RFID antenna 14.

The RFID antenna 14 may be set in the workspace 16 by multiple numbers or may be set on a wall or a floor of the workspace 16. In contrast to the embodiment, the RFID antenna 14 may be carried by the robot 18 and the RFID tag 12 may be set at a place of the ceiling, the wall or the floor in the workspace 16.

In the embodiment, an ultrasonic tag system accurately detects a three-dimensional position of the RFID tag 12 by detecting the position of an ultrasonic tag 24 placed adjacent to the RFID tag 12.

The ultrasonic tag system can accurately determine a three-dimensional position of the ultrasonic tag 24 with a margin of error in the order of several centimeters. With the ultrasonic tag system, a correct three-dimensional position coordinate of the RFID tag 12 can be recognized so that the radio communicative region can be accurately measured.

In the embodiment, the ultrasonic tag 24 is carried on a palm of the hand 18f of the robot 18 together with the RFID tag 12. The ultrasonic tag 24 and the RFID tag 12 may be integrated into one unit. Because the ultrasonic tag 24 and the RFID tag 12 have a predetermined positional relationship, when the three-dimensional position of the ultrasonic tag 24 is determined, the three-dimensional position of the RFID tag 12 is also determined taking into consideration of displacement of a joint angle of the robot 18.

In the embodiment, a plurality of ultrasonic receivers 26 are placed in the form of a grid on the ceiling of the workspace 16. With the ultrasonic receivers spaced uniformly, ultrasonic signals transmitted from the ultrasonic tag 24 can be detected with substantially the same measuring conditions at any position in the workspace 16 so that a uniform accuracy is obtained in determining the three-dimensional position of the ultrasonic tag 24 in the workspace. The grid space may be 50 cm, for example. The ultrasonic receivers 26 may have another arrangement. As the ceiling has a good measuring environment with substantially no obstacles, the ultrasonic receiver 26 is preferably placed on the ceiling of the workspace. The ultrasonic receiver 26 may be placed at a place other than the ceiling, such as the wall or the floor.

The controller 22 gives via the base station 30 an instruction to the ultrasonic tag 24 to transmit ultrasonic wave. The controller 22 determines a three-dimensional position of the ultrasonic tag 24 (i.e., the three-dimensional position of the RFID tag 12) based on a distance between the ultrasonic tag 24 and three or more receivers 26 that have received the ultrasonic signal. The three or more receivers 26 are preferably not aligned along a single line as can be seen with receivers 26a, 26b and 26c.

The three-dimensional position calculated in the embodiment is based on the three-dimensional coordinate axis 40 set in the workspace 16.

As shown in FIG. 1, the robot 18 in the embodiment is a two-legged robot that can autonomously move. The robot 18 can move in the workspace 16 according to the traveling path sent from the controller 22 via the base station 30 and can perform various tasks according to task execution instructions sent from the controller separately.

The robot 18 has two legs 18a, with a torso 18b thereon. A head 18c is associated with the torso 18b, and two arms 18d are associated with both sides of the torso 18b. A trunk 18e is provided on the back of the torso 18b and contains a control unit 39 for controlling operations of the entire body. A battery is also contained in the trunk 18e.

Six joints are provided for each of right and left legs 18a of the robot 18. The joints are driven by actuators such as electric motors. The robot 18 drives joints of the legs 18a to walk in the three-dimensional space. The details of walking of the two-legged robot are disclosed in Japanese Patent Application Publication 2005-219206 and others.

The right and left arms 18d are provided with seven joints respectively, each of which is also driven by actuators such as electric motors. To each end of the right and left arms 18d, a five-fingered hand 18f is attached. The moving robot 18 can perform a desired task by driving each joint of the arms 18d and the hands 18f in an appropriate angle.

In the RCRMS 10 according to the embodiment, a region in the RFID tag system in which radio communication can be performed is measured as follows.

1) In the workspace 16 with an RFID antenna 14 set on the ceiling and a plurality of ultrasonic receivers 26 set in a form of a grid on the ceiling, the robot 18 carrying the RFID tag 12 and the ultrasonic tag 24 on the palms of the hands 18f moves randomly or along a predetermined path according to a command given by the controller 22. The robot 18 carries the RFID tags 12 and the ultrasonic tags 24 with the hands 18f and moves them in various regions in the workspace 16 by moving the arms 18d, the legs 18a, etc. according to a command from the controller 22.

2) The controller 22 gives an instruction to the RFID tag system and the ultrasonic tag system to transmit a signal at a predetermined timing or a random timing in the movement of the robot 18.

3) The controller 22 checks whether the RFID antenna 14 has detected an electric wave from the RFID tag 12 or not at each measuring point and calculates a three-dimensional position of the ultrasonic tag 24 (and the RFID tag 12) based on a distance between the ultrasonic tag 24 and the three or more ultrasonic receivers which are not on the same line (for example, 26a, 26b and 26c).

4) The receiving conditions of the electric wave from the RFID tag 12 and the three-dimensional position of the RFID tag 12 are synchronized with each other and recorded.

Unlike the conventional method, the method for measuring the radio communicative region according to the present invention relieves a burden on an operator, as the robot 18 automatically moves the tag 12 to measuring points. According to the present invention, the number of measuring points is easily increased to further improve accuracy of the measurement. If the robot 18 is used to perform various tasks in a living space of a user, latest information on the radio communicative region is accumulated as the robot 18 performs usual tasks. Based on such latest information, the RFID antennae 14 and the ultrasonic receivers 26 may be rearranged when the layout of the space is changed.

Enhanced measuring accuracy of the radio communicative region according to the invention also improves the design of the radio communication system. For example, with correct recognition of the radio communicative region, the arrangement and number of the transmitters and receivers optimal for the radio communication in the workspace 16 can be selected.

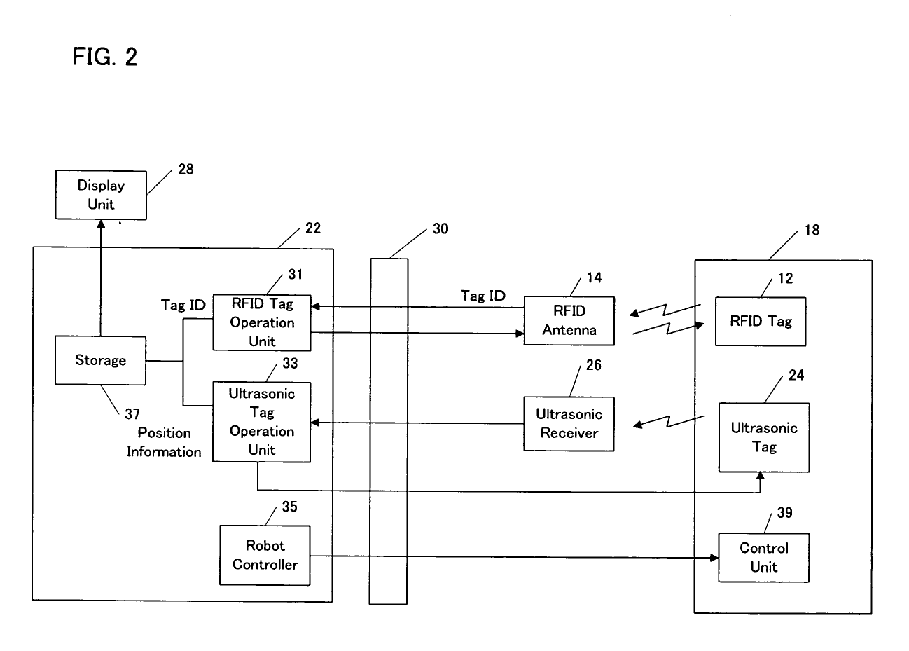

Now, the RCRMS 10 will be described in detail with reference to FIG. 2. FIG. 2 is a functional block diagram of the RCRMS according to the embodiment.

The controller 22 has an RFID tag operation unit 31, an ultrasonic tag operation unit 33, a robot controller 35 and a storage 37.

The RFID tag operation unit 31 sends via RFID antenna 14 to the RFID tag 12 an electric wave and receives the tag ID of the detected RFID tag 12 from the RFID antenna 14. The frequency band to be used for the RFID tag system may be 13.56 MHz, 950 MHz, 2.45 GHz or the like.

When the RCRMS (radio communicative region measuring system) of the present invention is activated, the RFID tag operation unit 31 sends an instruction to the RFID antenna 14 to transmit an electric wave. Responsive to the instruction, the RFID antenna 14 transmits an electric wave to the RFID tag 12. The RFID tag 12 obtains electricity from the electric wave it receives from the RFID antenna 14, and returns the electric signal including the tag ID of itself to the REID antenna 14.

Then, the RFID antenna 14 detects the tag ID from the electric signal it receives from the RFID tag 12, and sends it to the RFID tag operation unit 31. If the RFID antenna 14 cannot detect an electric wave from the RFID tag 12, it sends NAN (Not A Number) to the RFID tag operation unit 31 as a tag ID. The RFID tag operation unit 31 sends the obtained tag ID to the storage 37.

The ultrasonic tag system uses a frequency band at 20 kHz or more (for example, around 40 kHz). A frequency band that is selected for detecting a good position according to a communication environment or the like is used for the frequency band as required.

The ultrasonic tag operation unit 33 sends an instruction to the ultrasonic tag 24 to transmit an ultrasonic wave, responsive to which the ultrasonic tag 24 transmits ultrasonic signal to a plurality of ultrasonic receivers 26 arranged on the ceiling in the workspace 16 in a form of a grid. The ultrasonic receivers 26 that received the ultrasonic signals send the reception signal to the ultrasonic tag operation unit 33.

When the ultrasonic tag operation unit 33 receives the reception signal, it selects three ultrasonic receivers, which are not on the same line (for example, 26a, 26b and 26c in FIG. 1) among the ultrasonic receivers 26 that have sent reception signals. Then, the ultrasonic tag operation unit 33 calculates the distances 1ₐ, 1_{b} and 1_{c} respectively from the ultrasonic tag 24 to the selected ultrasonic receivers (26a, 26b and 26c) based on difference between the time when the ultrasonic tag 24 transmitted ultrasonic wave and the time when the reception signals are received.

Then, the ultrasonic tag operation unit 33 calculates a three-dimensional position of the ultrasonic tag 24 based on the calculated distance 1ₐ, 1_{b}, 1_{c} and the positional coordinate of each of the receivers 26a, 26b and 26c. The three-dimensional positional coordinate (x, y, z) of the ultrasonic tag 24 can be calculated by solving the simultaneous equations for triangulation shown below.
(Xₐ−x)²+(Yₐ−y)²+(Zₐ−z)²=1ₐ² (1)
(X_{b}−x)²+(Y_{b}−y)²+(Z_{b}−z)²=1_{b}² (2)
(X_{c}−x)²+(Y_{c}−y)²+(Z_{c}−z)²=1_{c}² (3)

Here, (Xₐ, Yₐ, Zₐ), (X_{b}, Y_{b}, Z_{b}), (X_{c}, Y_{c}, Z_{c}) are coordinates of the ultrasonic receivers 26a, 26b and 26c in the workspace 16, respectively. The (x, y, z) is a coordinate of a three-dimensional position of the ultrasonic tag 24 in the workspace 16. The coordinates are based on a three-dimensional coordinate (for example, a coordinate axis denoted by the reference numeral 40 in FIG. 1) set in the workspace 16. 1ₐ to 1_{b} are distances between the ultrasonic receivers 26a, 26b and 26c and the ultrasonic tag 24, respectively. The three-dimensional position of the ultrasonic tag 24 may be determined based on the distance more correctly by using the least square method, for example, on the result obtained from various combinations of the three ultrasonic receivers.

The ultrasonic tag operation unit 33 sends the calculated three-dimensional position of the ultrasonic tag 24 to the storage 37 as position information.

The storage 37 stores the tag ID obtained by the RFID tag operation unit 31 and the position information calculated at the ultrasonic tag operation unit 33 as a data set associated with each other. The data stored in the storage 37 is provided to the display unit 28 for visual display.

On the other hand, the robot controller 35 sends an operational instruction for the robot 18 to the control unit 39. The operational instruction may be an instruction for measuring a radio communicative region defined in advance or an operational instruction according to a task command given by a user. When the control unit 39 of the robot 18 receives the operational instruction, it controls the arms 18a, the legs 18d and other parts of the robot 18 to move/operate the robot in the workspace 16 along the path according to the operational instruction.

The RFID tag operation unit 31, the ultrasonic tag operation unit 33 and the robot controller 35 may be realized by a CPU (central processing unit) that performs various computation according to a computer program stored in the storage 37. The RFID tag operation unit 31, the ultrasonic tag operation unit 33, the robot controller 35 and the storage 37 may be integrated into one unit.

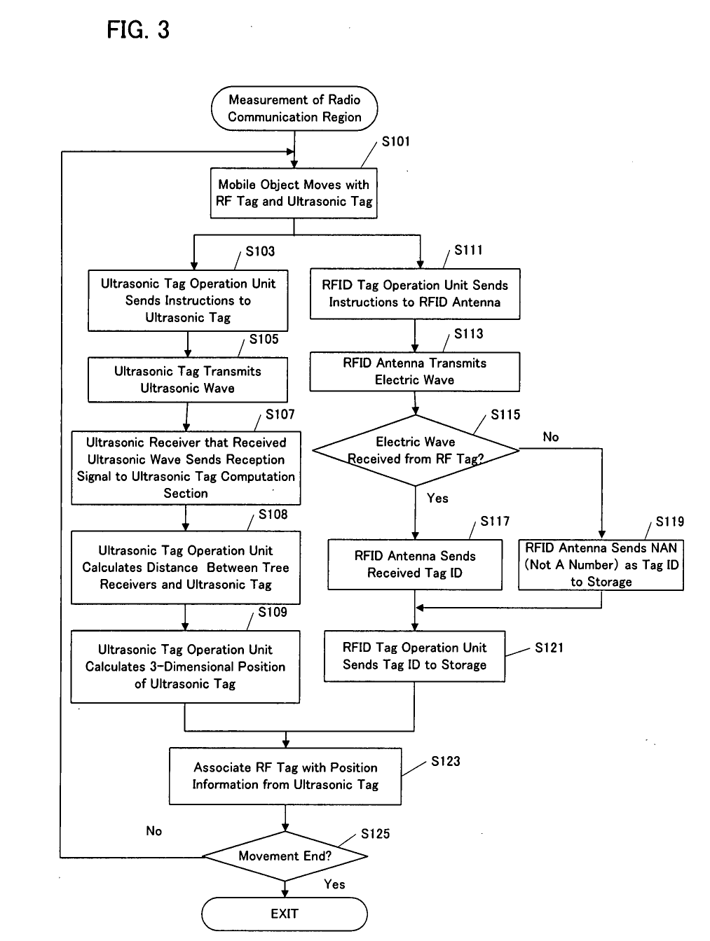

Now, the process for measuring the radio communicative region by the controller 22 will be described with reference to FIG. 3. FIG. 3 is a flowchart of the radio communicative region measuring process by the controller 22.

At step S101, in response to a command from the robot controller 35, the robot 18 carrying the RFID tag 12 and the ultrasonic tag 24 moves in the workspace 16 along a predetermined path. The traveling path for the robot 18 is prepared for a task of measuring the radio communicative region according to the embodiment. The traveling path may be stored in the storage in the robot, for example. Alternatively, the robot 18 may randomly move in the workspace 16. The robot 18 changes positions of the RFID tag 12 and the ultrasonic tag 24 by moving the arms 18d, as it moves along the path. In this manner, the robot 18 covers various regions in the workspace 16.

Next at steps S103 to S109, position information is calculated by the ultrasonic tag system.

At step S103, the ultrasonic tag operation unit 33 sends an instruction to transmit an ultrasonic signal to the ultrasonic tag 24. At step S105, in response to the transmit instruction, the ultrasonic tag 24 transmits an ultrasonic signal.

At step S107, an ultrasonic receiver 26 that received the ultrasonic signal transmitted from the ultrasonic tag 24 among the plurality of ultrasonic receivers 26 arranged on the ceiling of the workspace 16 sends a reception signal to the ultrasonic tag operation unit 33.

At step S108, the ultrasonic tag operation unit 33 selects a set of three ultrasonic receivers (26a, 26b and 26c), which are not on the same line, from among the ultrasonic receivers that sent the reception signal. The ultrasonic tag operation unit 33 calculates the distances 1ₐ, 1_{b} and 1_{c} from the ultrasonic tag 24 relative to the selected ultrasonic receivers (26a, 26b and 26c) based on time of flight of the ultrasonic wave between the time of the transmission or transmission instruction and the time of reception.

At step S109, the ultrasonic tag operation unit 33 calculates a three-dimensional position of the ultrasonic tag 24 based on the calculated distances 1ₐ, 1_{b}, 1_{c} and the position coordinates of respective receivers 26a, 26b and 26c. The three-dimensional position of the ultrasonic tag 24 is calculated by using equations (1) to (3). The calculated three-dimensional position of the tag is sent to the storage 37 as position information. The three-dimensional position of the ultrasonic tag 24 may be calculated more accurately by using the least square method, for example, on the result obtained from various combinations of the three ultrasonic receivers.

At steps S111 to S121, a tag ID is detected by the RFID tag system. The process is performed in parallel with calculation of position information by the ultrasonic tag system.

At step S111, the RFID tag operation unit 31 sends a transmit instruction to the RFID antenna 14. At step S113, the RFID antenna 14 transmits an electric wave in response to the transmit instruction.

At step S115, the RFID antenna 14 checks whether the RFID antenna 14 has received an electric signal returned from the RFID tag 12 or not. If it received the electric signal, it is determined that the RFID tag 12 is within a communication range of the RFID antenna 14 and the operation proceeds to step S117, where the tag ID detected from the received electric signal is sent to the RFID tag operation unit 31. If it did not receive the electric signal at step S115, it is determined that the RFID tag 12 is outside the communication range of the RFID antenna 14 and the operation proceeds to step S119, where data of NAN (Not A Number) is sent to the RFID tag operation unit 31 as a tag ID. At step S121, the RFID tag operation unit 31 sends the ID information of the RFID tag 12 to the storage 37.

At step S123, the position information of the ultrasonic tag 24 and the ID information of the RFID tag 12 are stored in the storage 37 together.

At step S125, the robot 18 determines whether a command to terminate an operation is issued or not, or whether all operation under the command has terminated. If there is a travel path to be followed, the operation returns to step S101 and measurement is carried out along the remaining path. If the travel path is terminated, the process ends.

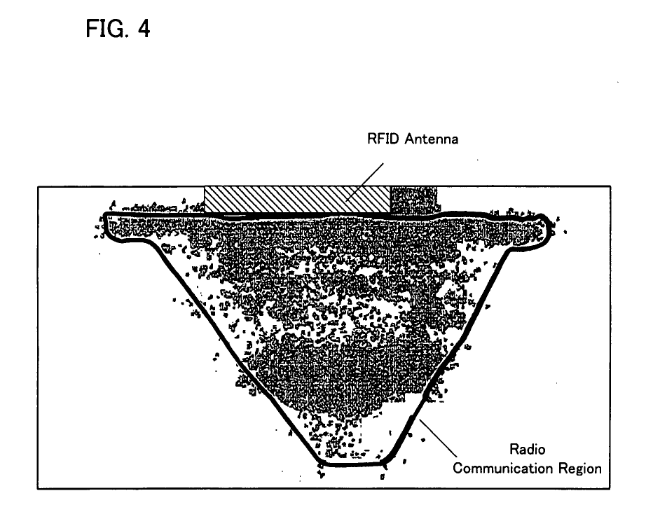

FIG. 4 is an example of measurement data of the radio communicative region by the radio communicative region measuring system 10 displayed on the display unit 28. For simplicity, FIG. 4 shows only a part of the workspace 16 instead of its entirety. The vertical axis and the horizontal axis of the graph respectively correspond to position coordinates in the direction of height and the horizontal direction of the workspace 16.

Dots shown on the graph of FIG. 4 are the measurement points where the RFID antennae 14 received the tag ID of the RFID tag 12 and their three dimensional positions determined by the ultrasonic tag operation unit 33. The solid line shown in FIG. 4 shows a radio communicative region of the RFID tag system determined based on the distribution of the measurement points where the tag ID is received.

As shown in FIG. 4, dots of positions where the RFID antenna 14 can receive the tag ID of the RFID tag 12 provides visual view of a region in the RFID tag system, in which radio communication can be performed. Various types of verification may be made by changing the type of tags, outputs of tag, the number of antennae and tags, and arrangement so as to enable optimal radio communication system to be designed and operated.

As the three-dimensional position of the ultrasonic tag 24 is determined at step S123 as mentioned above, a region in the RFID system, in which the radio communication can be performed may be displayed on the display unit 28.

According to the present invention, a region in the RFID system, in which radio communication can be performed, can be accurately measured even in an environment unique to a workspace such as a layout of chairs or a desk.

Although the invention has been described about specific embodiments, the present invention is not limited to the embodiments and may be modified without departing from a spirit of the present invention.

Although the ultrasonic tag system is applied as means for accurately detecting a three-dimensional position of the RFID tag 12 in the abovementioned embodiment, an infrared tag system with high position detecting accuracy may be used. Similarly, means for detecting a position of the RFID tag 12 from an image taken by a camera set in the robot 18 or the workspace 16 may be used or a well-known X-Y-Z plotter may be used.

Although a two-legged robot is exemplified as a specific example of the robot 18 in the abovementioned embodiment, the robot 18 of the present invention is not limited to a two-legged robot, and may be a device with other moving means such as wheels to be able to autonomously move or a crane provided with the RFID tag 12 and the ultrasonic tag 24 at the end.

Although the radio communicative region of the RFID tag system is measured, while the robot 18 carrying an RFID tag 12 or an RFID antenna 14 moves in a workspace in the abovementioned embodiment, instead of the robot 18, a person may carry an RFID tag 12 or an RFID antenna 14 and measure the radio communicative region by moving in a workspace. In such a case, it is desirable to move the RFID tag 12 or the RFID antenna 14 without rotary motion and the like so that the positional relationship between the RFID tag 12 or the RFID antenna 14 and the ultrasonic tag 24 does not change.

Although the radio communicative region is measured while the robot operates according to a predetermined operational command in the abovementioned embodiment, the operational command may be set again to more accurately move or operate the robot 18 near the boundary of the communicative region as to measure the boundary clearly.

What is claimed is:

1. A radio communicative region measuring system for measuring a region in a workspace in which radio communication can be performed, comprising:
a mobile object that can move in said workspace;
a radio transmitter or a radio receiver carried by said mobile object for sending or receiving a unique radio signal;
a radio receiver or a radio transmitter provided in said workspace for receiving or sending said unique radio signal;
means for determining receiving conditions of said unique radio signal received by said receiver as said mobile object moves in said workspace;
means for detecting the position of said radio transmitter or said radio receiver as said mobile object moves in said workspace; and
means for determining a region in which radio communication can be performed between said radio transmitter and said radio receiver based on said receiving conditions and the detected positions.

2. The system according to claim 1, wherein said radio transmitter is an RFID tag and said radio receiver an RFID antenna, and wherein said means for detecting the position comprises:
a tag system including an ultrasonic or infrared transmitter carried by said mobile object and a plurality of ultrasonic or infrared receivers provided in the workplace.

3. The system according to claim 2, wherein said ultrasonic or infrared receivers provided in the workplace are in a form of a grid with predetermined intervals provided on at least one of the ceiling, the wall or the floor of said workspace.

4. The system according to claim 1, wherein said radio transmitter is a RFID tag and said radio receiver is a RFID antenna, and the RFID tag or the RFID antenna provided on at least one of the ceiling, the wall or the floor of said workspace, and said means for detecting a position comprises:
an image system with a camera provided to said mobile object.

5. The system according to claim 1, wherein said mobile object is a legged or wheeled autonomous robot.

6. A method for measuring a region in a workplace in which radio communication can be made, comprising:
moving a mobile object in said workspace carrying a radio transmitter or a radio receiver, said workplace being provided with a radio receiver or a radio transmitter for receiving or sending a unique radio signal;
said radio transmitter sending said unique radio signal;
determining receiving conditions of said unique radio signal received by said receiver as said mobile object moves in said workspace;
detecting the position of said radio transmitter or said radio receiver when said radio receiver receives said unique radio signal; and
determining a region in which radio communication can be performed between said radio transmitter and said radio receiver based on said receiving conditions and the detected positions.

7. The method according to claim 6, wherein said radio transmitter is an RFID tag and said radio receiver an RFID antenna, and wherein said detecting of the position is performed by a tag system including an ultrasonic or infrared transmitter carried by said mobile object and a plurality of ultrasonic or infrared receivers provided in the workplace.

8. The method according to claim 7, wherein said radio receiver or said radio transmitter is provided on at least one of a ceiling, a wall or a floor of said workspace, and said ultrasonic or infrared transmitter is provided to be in substantially the same positional relationship relative to said radio transmitter or a radio receiver carried by the mobile object, and said ultrasonic or infrared receivers are provided on at least one of the ceiling, the wall or the floor of said workspace.

9. A method for measuring a region in a workspace in which radio communication can be performed, comprising:
moving a radio transmitter or a radio receiver in said workspace, said workplace being provided with a radio receiver or a radio transmitter for receiving or sending a unique radio signal;
said radio transmitter sending said unique radio signal;
determining receiving conditions of said unique radio signal received by said receiver as said radio transmitter or said radio receiver is moved in said workspace;
detecting the position of said radio transmitter or said radio receiver when said radio receiver receives said unique radio signal; and
determining a region in which radio communication can be performed between said radio transmitter and said radio receiver based on said receiving conditions and the detected positions.

10. The method according to claim 9, wherein said radio transmitter is an RFID tag and said radio receiver an RFID antenna, and wherein said detecting of the position is performed by a tag system including an ultrasonic or infrared transmitter carried by said mobile object and a plurality of ultrasonic or infrared receivers provided in the workplace.

11. The method according to claim 10, wherein said radio receiver or said radio transmitter is provided on at least one of a ceiling, a wall or a floor of said workspace, and said ultrasonic or infrared transmitter is provided to be in substantially the same positional relationship relative to said radio transmitter or a radio receiver carried by the mobile object, and said ultrasonic or infrared receivers are provided on at least one of the ceiling, the wall or the floor of said workspace.

12. A computer readable medium storing a computer program for measuring a region in a workplace in which radio communication can be performed, wherein said computer program, when executed, performs:
moving a mobile object in said workspace carrying a radio transmitter or a radio receiver, said workplace being provided with a radio receiver or a radio transmitter for receiving or sending a unique radio signal;
making said radio transmitter send said unique radio signal;
determining receiving conditions of said unique radio signal received by said receiver as said mobile object moves in said workspace;
detecting the position of said radio transmitter or said radio receiver when said radio receiver receives said unique radio signal; and
determining a region in which radio communication can be performed between said radio transmitter and said radio receiver based on said receiving conditions and the detected positions.

13. The medium according to claim 12, wherein said radio transmitter is an RFID tag and said radio receiver an RFID antenna, and wherein said detecting of the position is performed by a tag system including an ultrasonic or infrared transmitter carried by said mobile object and a plurality of ultrasonic or infrared receivers provided in the workplace.

14. The medium according to claim 13, wherein said radio receiver or said radio transmitter is provided on at least one of a ceiling, a wall or a floor of said workspace, and said ultrasonic or infrared transmitter is provided to be in substantially the same positional relationship relative to said radio transmitter or a radio receiver carried by the mobile object, and said ultrasonic or infrared receivers are provided on at least one of the ceiling, the wall or the floor of said workspace.

15. A display system for displaying a region in a workplace in which radio communication can be performed, comprising:
a mobile object that can move in said workspace;
a radio transmitter or a radio receiver carried by said mobile object for sending or receiving a unique radio signal;
a radio receiver or a radio transmitter provided in said workspace for receiving or sending said unique radio signal;
means for determining receiving conditions of said unique radio signal received by said receiver as said mobile object moves in said workspace;
means for detecting the position of said radio transmitter or said radio receiver as said mobile object moves in said workspace; and
means for determining a region in which radio communication can be performed between said radio transmitter and said radio receiver based on said receiving conditions and the detected positions a display unit for displaying the determined region.

16. The display system according to claim 15, wherein said radio transmitter is an RFID tag and said radio receiver an RFID antenna, and wherein said means for detecting the position comprises:
a tag system including an ultrasonic or infrared transmitter carried by said mobile object and a plurality of ultrasonic or infrared receivers provided in the workplace.

17. The system according to claim 16, wherein said ultrasonic or infrared receivers provided in the workplace are in a form of a grid with predetermined intervals provided on at least one of the ceiling, the wall or the floor of said workspace.

18. The system according to claim 15, wherein said radio transmitter is a RFID tag and said radio receiver is a RFID antenna, and the RFID tag or the RFID antenna provided on at least one of the ceiling, the wall or the floor of said workspace, and said means for detecting a position comprises:
an image system with a camera provided to said mobile object.

19. The system according to claim 15, wherein said mobile object is a legged or wheeled autonomous robot.
